(19) United States
(12) Patent Application Publication
(10) Pub. No.: US 2022/0124129 A1
(43) Pub. Date: Apr. 21, 2022

(54) INFORMATION PROCESSING SYSTEM, INFORMATION PROCESSING METHOD, AND RECORDING MEDIUM HAVING RECORDED THEREON INFORMATION PROCESSING PROGRAM

(71) Applicant: SHARP KABUSHIKI KAISHA, Osaka (JP)

(72) Inventors: YOSUKE OSAKI, Osaka (JP); KEIKO HIRUKAWA, Osaka (JP); AKIHIRO KUMATA, Osaka (JP)

(21) Appl. No.: 17/499,756

(22) Filed: Oct. 12, 2021

(30) Foreign Application Priority Data
Oct. 19, 2020 (JP) 2020-175158

(51) Int. Cl. H04L 29/06; H04W 76/30

(52) U.S. Cl. CPC H04L 65/403; H04W 76/30

(57) ABSTRACT

An information processing system includes: a first acquisition processor that acquires time and date information indicating time and date of the conference and conference room information indicating a conference room in which the conference is held; a second acquisition processor that acquires, from a storage that stores the conference room information indicating the conference room and unique device information on the device used for the conference in the conference room in association with each other, the device information on a predetermined device based on the conference room information acquired by the first acquisition processor; and a connection processor that connects the user terminal to the device based on the device information acquired by the second acquisition processor.

### INCORPORATION BY REFERENCE

This application is based upon and claims the benefit of priority from the corresponding Japanese Patent Application No. 2020-175158 filed on Oct. 19, 2020, the entire contents of which are incorporated herein by reference.

### BACKGROUND

The present disclosure relates to an information processing system, an information processing method, and a recording medium having recorded thereon an information processing program.

There are conventionally known technologies for pairing a user terminal with a device (peripheral device) capable of short-range wireless communications and connecting the user terminal to the device. For example, there is a known technology in which a user terminal detects a device capable of short-range wireless communications and transmits, to a management server, a request for acquiring pairing information on the device, the management server transmits the pairing information to the user terminal in response to the received request for acquiring the pairing information, and the user terminal performs a data communication with the device based on the pairing information in response to the received pairing information.

According to a conventional technology, to connect to, for example, a Bluetooth (registered trademark) compatible device, the device is detected by using a device detection function of an OS, a user terminal and the device are paired by using a pairing function of the OS, and, after the pairing is successful, the user terminal is connected to the device. This results in a time-consuming operation to connect the user terminal to the device.

When a plurality of devices of the identical model is present in a Bluetooth detection range, the user terminal displays the identical device names during search for a device, which causes a problem in that it is difficult for the user to know which device to be paired with.

In particular, when a conference is conducted by connecting a user terminal and a device used for the conference in a conference room, a connection process is time-consuming and thus results in a problem of an inefficient conference.

### SUMMARY

An object of the present disclosure is to provide an information processing system, an information processing method, and a recording medium having recorded thereon an information processing program, which enables easy connection with a device used for a conference and thus an efficient conference.

An information processing system according to one aspect of the present disclosure is an information processing system that connects a user terminal of a user participating in a conference to a device used for the conference, and the information processing system includes: a first acquisition processor that acquires time and date information indicating time and date of the conference and conference room information indicating a conference room in which the conference is held; a second acquisition processor that acquires, from a storage that stores the conference room information indicating the conference room and unique device information on the device used for the conference in the conference room in association with each other, the device information on a predetermined device based on the conference room information acquired by the first acquisition processor; and a connection processor that connects the user terminal to the device based on the device information acquired by the second acquisition processor.

An information processing method according to another aspect of the present disclosure is an information processing method for connecting a user terminal of a user participating in a conference to a device used for the conference, and the information processing method includes: by one or more processors, first acquiring time and date information indicating time and date of the conference and conference room information indicating a conference room in which the conference is held; second acquiring, from a storage that stores the conference room information indicating the conference room and unique device information on the device used for the conference in the conference room in association with each other, the device information on a predetermined device based on the conference room information acquired at the first acquiring; and connecting the user terminal to the device based on the device information acquired at the second acquiring.

A recording medium according to another aspect of the present disclosure is a recording medium having recorded thereon an information processing program for connecting a user terminal of a user participating in a conference to a device used for the conference, and the information processing program causes one or more processors to execute: first acquiring time and date information indicating time and date of the conference and conference room information indicating a conference room in which the conference is held; second acquiring, from a storage that stores the conference room information indicating the conference room and unique device information on the device used for the conference in the conference room in association with each other, the device information on a predetermined device based on the conference room information acquired at the first acquiring; and connecting the user terminal to the device based on the device information acquired at the second acquiring.

According to the present disclosure, it is possible to provide an information processing system, an information processing method, and a recording medium having recorded thereon an information processing program, which enables easy connection with a device used for a conference and thus an efficient conference.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a schematic configuration of a conference system according to an embodiment of the present disclosure.

FIG. 2 is a functional block diagram illustrating a configuration of the conference system according to the embodiment of the present disclosure.

FIG. 3 is a table illustrating an example of conference information used in the conference system according to the embodiment of the present disclosure.

FIG. 4 is a table illustrating an example of installed device information used in the conference system according to the embodiment of the present disclosure.

FIG. 5 is a table illustrating an example of device connection information used in the conference system according to the embodiment of the present disclosure.

FIG. 6 is a diagram illustrating an example of a display screen of a user terminal according to the embodiment of the present disclosure.

FIG. 7 is a diagram illustrating an example of the display screen of the user terminal according to the embodiment of the present disclosure.

FIG. 8 is a diagram illustrating an example of the display screen of the user terminal according to the embodiment of the present disclosure.

FIG. 9 is a diagram illustrating an example of the display screen of the user terminal according to the embodiment of the present disclosure.

FIG. 10 is a flowchart illustrating an example of a procedure of a conference support process executed by the conference system according to the embodiment of the present disclosure.

FIG. 11 is a flowchart illustrating an example of a procedure of the conference support process executed by the conference system according to the embodiment of the present disclosure.

FIG. 12 is a table illustrating another example of the conference information used in the conference system according to the embodiment of the present disclosure.

FIG. 13 is a flowchart illustrating an example of a procedure of the conference support process executed by the conference system according to the embodiment of the present disclosure.

### DETAILED DESCRIPTION

An embodiment of the present disclosure is described below with reference to the accompanying drawings. The embodiment below is an example obtained by embodying the present disclosure and does not intend to limit the technical scope of the present disclosure.

An information processing system according to the present disclosure is applicable to, for example, a remote conference participated by a plurality of users at different locations (conference rooms). A conference system according to the present embodiment is an example of the information processing system according to the present disclosure. For example, in the conference system according to the present embodiment, a conference room includes a user terminal used by a user participating in a conference, a display that presents a display screen, or the like, of the user terminal, and a speakerphone that transmits and receives the user's voice. The conference system includes a management server that manages information about a conference, a conference room, a device used for the conference, etc.

Conference System 100

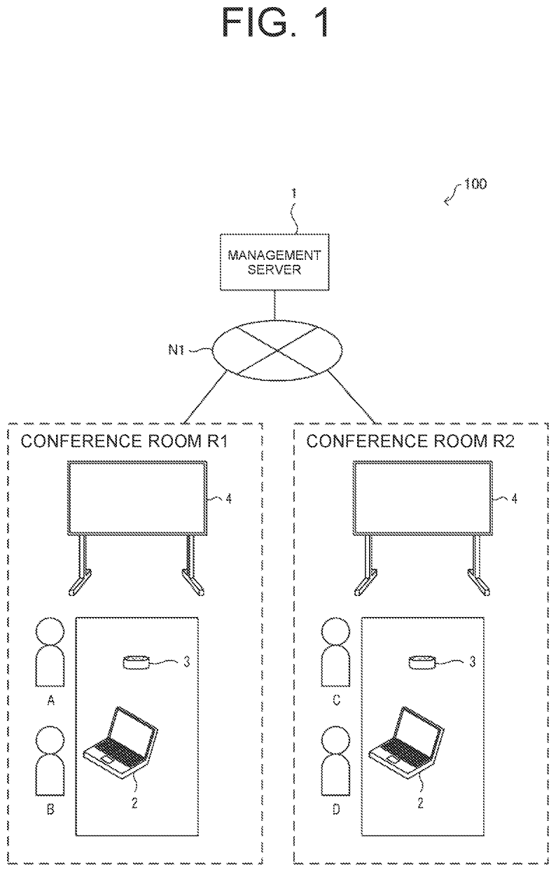

FIG. 1 is a diagram illustrating a schematic configuration of a conference system according to an embodiment of the present disclosure. A conference system 100 includes a management server 1, a user terminal 2, a speakerphone 3, and a display 4. FIG. 1 illustrates a conference room R1 and a conference room R2. The conference room R1 includes the user terminal 2, the speakerphone 3, and the display 4 that are used by a user A and a user B who are participants in a conference. The conference room R2 includes the user terminal 2, the speakerphone 3, and the display 4 that are used by a user C and a user D who are participants in the conference. In the conference system 100, the user terminal 2 of the user participating in the conference is coupled to devices (the speakerphone 3, the display 4, etc.) used for the conference. For example, the users A, B, C, and D conduct a remote conference in the conference room R1 and the conference room R2 by using the user terminals 2 and the devices coupled.

The management server 1 is configured with, for example, one or more data servers (virtual servers). The user terminal 2 may be the user's own terminal device that is brought into the conference room by the user participating in the conference. The conference room may include, for example, the user terminals 2 corresponding to the number of users participating in the conference.

The management server 1, the user terminal 2, the speakerphone 3, and the display 4 are connected to each other via a network N1. The network N1 is a communication network such as the Internet, a LAN, a WAN, or a public telephone line. The user terminal 2 and the speakerphone 3 are connected to each other via a short-range wireless communication (e.g., Bluetooth communication), a LAN, etc. Similarly, the user terminal 2 and the display 4 are connected to each other via a short-range wireless communication (e.g., Bluetooth communication), a LAN, etc. The speakerphone 3 and the display 4 are examples of a device according to the present disclosure.

Management Server 1

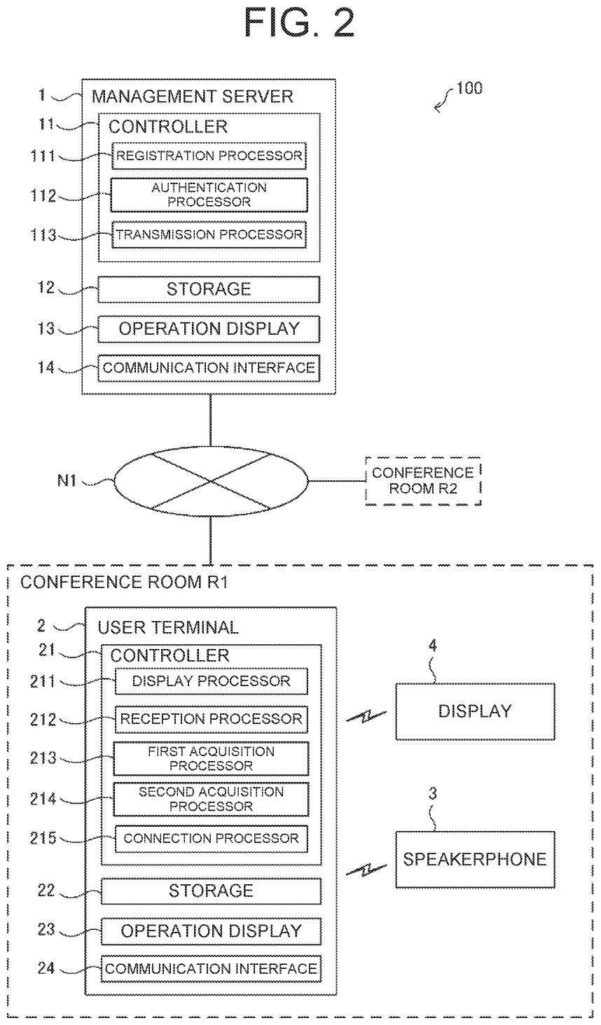

As illustrated in FIG. 2, the management server 1 includes a controller 11, a storage 12, an operation display 13, a communication interface 14, etc. The management server 1 may include one or more virtual servers (cloud servers) or may include one or more physical servers.

The communication interface 14 is a communication interface for connecting the management server 1 to the network N1 by wire or wirelessly and for executing data communications in accordance with a predetermined communication protocol with other devices (e.g., the user terminal 2) via the network N1.

The operation display 13 is a user interface including a display, such as a liquid crystal display or an organic EL display, which presents various types of information, and an operator, such as a mouse, a keyboard, or a touch panel, which receives operations. The operation display 13 receives, for example, operations of an administrator of the management server 1.

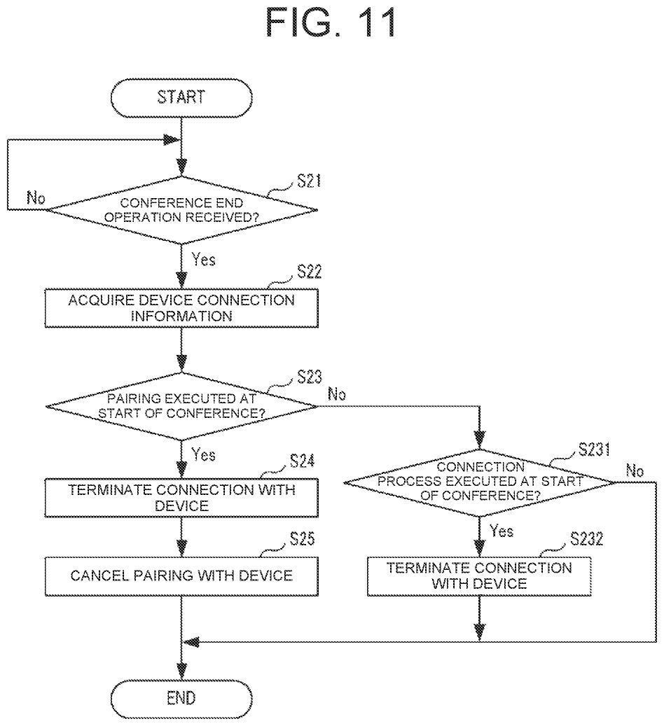

The storage 12 is a non-volatile storage, such as a hard disk drive (HDD), a solid state drive (SSD), or a flash memory, which stores various types of information. The storage 12 stores a control program such as a conference support program for causing the controller 11 to execute a conference support process (see FIGS. 10 and 11) described below. For example, the conference support program is temporarily recorded on a computer-readable recording medium such as a CD or a DVD, read by a reading device (not illustrated) such as a CD drive or a DVD drive included in the management server 1, and stored in the storage 12. The conference support program may be distributed from a cloud server and stored in the storage 12.

The storage 12 stores various types of information to support the conference. Specifically, the storage 12 stores data such as conference information D1 about the schedule of the conference and installed device information D2 about a device installed in the conference room.

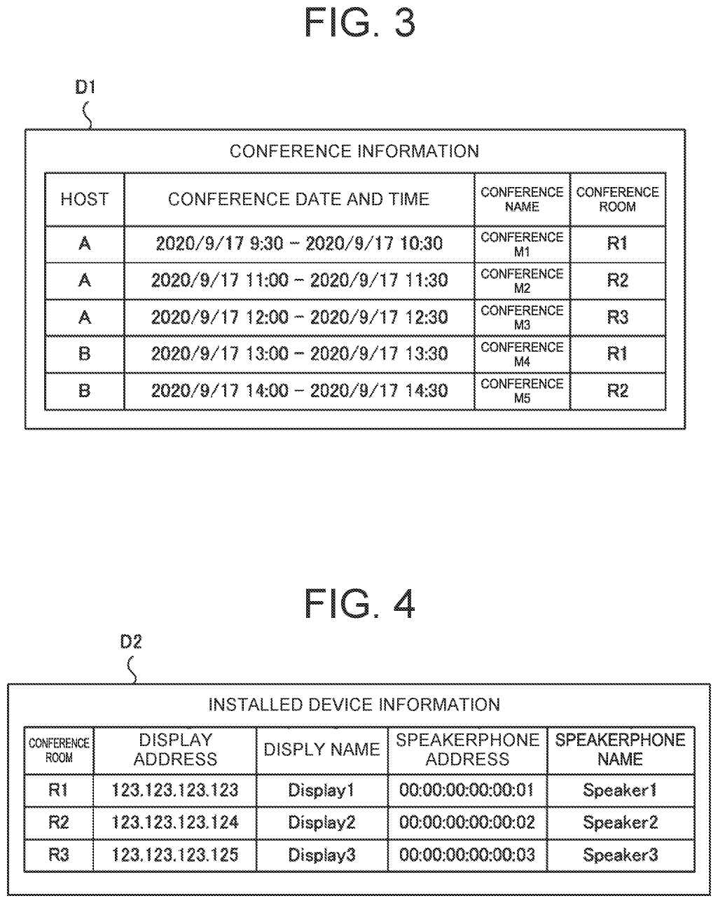

FIG. 3 is a table illustrating an example of the conference information D1. In the conference information D1, information such as host, conference time and date, conference name, and conference room, are registered in association with each other for each conference. The host is information indicating the host (user) of the conference. The conference time and date is time and date information including the date, the start time, and the end time of the conference. The conference name is information indicating the name of the conference. The conference room is information indicating the location where the conference is held. The identification information (user ID) on the user participating in the conference may be registered in the conference information D1. For example, the host uses the user terminal 2 to activate a conference support application and enters each piece of information on a registration screen so that the conference information D1 is registered.

FIG. 4 is a table illustrating an example of the installed device information D2. In the installed device information D2, the address information and the name of the device installed in the conference room are registered for each conference room. The device is a device used for the conference and includes, for example, the display 4 and the speakerphone 3. The device may be previously installed in the conference room or brought in at the start of the conference. The address information is the unique identification information (identification number) on the device. The name of the device may be registered by the user as appropriate. For example, the user may set and register the name so as to easily distinguish devices of the identical type. The address information and the name are examples of device information according to the present disclosure. Although two types of devices (display and speakerphone) are registered in the installed device information D2 in the example illustrated in FIG. 4, other devices (smart speaker, AI speaker, etc.) may be further registered.

All or some of the conference information D1 and the installed device information D2 may be stored in a server that is accessible from the management server 1. In this case, the controller 11 of the management server 1 may acquire the above-described information from the server and execute each process such as the conference support process (see FIGS. 10 and 11) described below.

The controller 11 includes control devices such as a CPU, a ROM, and a RAM. The CPU is a processor that executes various arithmetic operations. The ROM previously stores control programs such as a BIOS and an OS for causing the CPU to execute various processes. The RAM stores various types of information and is used as a temporary storage memory (work area) for various processes executed by the CPU. The controller 11 causes the CPU to execute various control programs previously stored in the ROM or the storage 12 to control the management server 1.

Specifically, the controller 11 includes various processing units such as a registration processor 111, an authentication processor 112, and a transmission processor 113. The controller 11 executes various processes in accordance with the conference support program to function as various processing units described above. All or some of the processing units included in the controller 11 may be configured by an electronic circuit. The conference support program may be a program that causes a plurality of processors to function as various processing units described above.

The registration processor 111 registers the conference information D1 (see FIG. 3) and the installed device information D2 (see FIG. 4). Specifically, when the user uses the user terminal 2 to activate the conference support application and registers the conference time and date, the conference name, the conference room, and the like, on the registration screen, the registration processor 111 acquires and registers these pieces of information in the conference information D1. When the user uses the user terminal 2 to activate the conference support application and registers the address information and the name of the device installed in each conference room on the registration screen, the registration processor 111 acquires and registers these pieces of information in the installed device information D2.

The authentication processor 112 executes an authentication process for the user. For example, when the user inputs user information (user ID and password) on a login screen of the conference support application displayed on the user terminal 2, the authentication processor 112 acquires the user ID and the password and executes the authentication process. When the user ID and the password of the user are registered in the user information (not illustrated), the authentication processor 112 authenticates the user and allows the user to use the conference support application.

When the authentication processor 112 authenticates the user, the transmission processor 113 transmits the conference information D1 (the time and date information, the conference name, and the conference room information) and the installed device information D2 to the user terminal 2.

User Terminal 2

As illustrated in FIG. 2, the user terminal 2 includes a controller 21, a storage 22, an operation display 23, a communication interface 24, etc. FIG. 2 illustrates the user terminal 2 of the user participating in the conference in the conference room R1.

The communication interface 24 is a communication interface for connecting the user terminal 2 to the network N1 by wire or wirelessly and for executing data communications in accordance with a predetermined communication protocol with other devices (e.g., the management server 1) via the network N1. The communication interface 24 is a communication interface for executing data communications in accordance with a predetermined communication protocol between the user terminal 2 and other devices (e.g., the display 4 or the speakerphone 3) via a short-range wireless communication (Bluetooth communication).

The operation display 23 is a user interface including a display, such as a liquid crystal display or an organic EL display, which presents various types of information, and an operator, such as a mouse, a keyboard, or a touch panel, which receives operations. The operation display 23 receives, for example, operations of the user of the user terminal 2.

The storage 22 is a non-volatile storage, such as HDD, SSD, or flash memory, which stores various types of information. The storage 22 stores a control program such as the conference support program for causing the controller 21 to execute the conference support process (see FIGS. 10 and 11) described below. For example, the conference support program is temporarily recorded on a computer-readable recording medium such as a CD or a DVD, read by a reading device (not illustrated) such as a CD drive or a DVD drive included in the user terminal 2, and stored in the storage 22. The conference support program may be distributed from a cloud server and stored in the storage 22.

The storage 22 stores various types of information for supporting the conference. Specifically, the storage 22 stores data such as device connection information D3 about the connection status of the device.

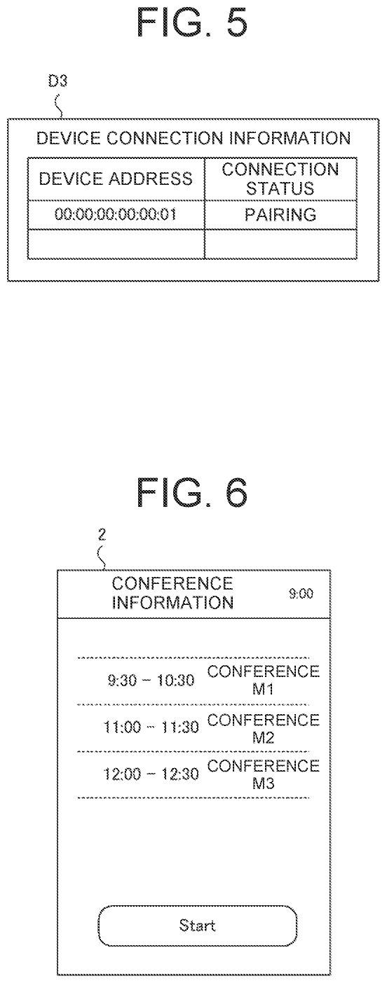

FIG. 5 is a table illustrating an example of the device connection information D3. The address information on the device connected to the user terminal 2 and the information (connection state) indicating the connection status are registered in the device connection information D3. FIG. 5 indicates that the user terminal 2 is paired with the speakerphone 3. That is, it indicates that the user terminal 2 and the speakerphone 3 have been paired. When the user terminal 2 is connected to the speakerphone 3 after pairing, “connect” is registered in the connection status. When the user terminal 2 is paired with or connected to a plurality of devices, the connection status is registered for each device. The controller 21 registers, updates, deletes, and the like, the device connection information D3.

The controller 21 includes control devices such as a CPU, a ROM, and a RAM. The CPU is a processor that performs various arithmetic operations. The ROM previously stores control programs such as a BIOS and an OS for causing the CPU to execute various processes. The RAM stores various types of information and is used as a temporary storage memory (work area) for various processes executed by the CPU. The controller 21 causes the CPU to execute various control programs previously stored in the ROM or the storage 22 to control the user terminal 2.

Specifically, the controller 21 includes various processing units such as a display processor 211, a reception processor 212, a first acquisition processor 213, a second acquisition processor 214, and a connection processor 215. The controller 21 causes the CPU to execute various processes in accordance with the control program to function as various processing units described above. All or some of the processing units included in the controller 21 may be configured by an electronic circuit. The control program may be a program that causes a plurality of processors to function as various processing units described above.

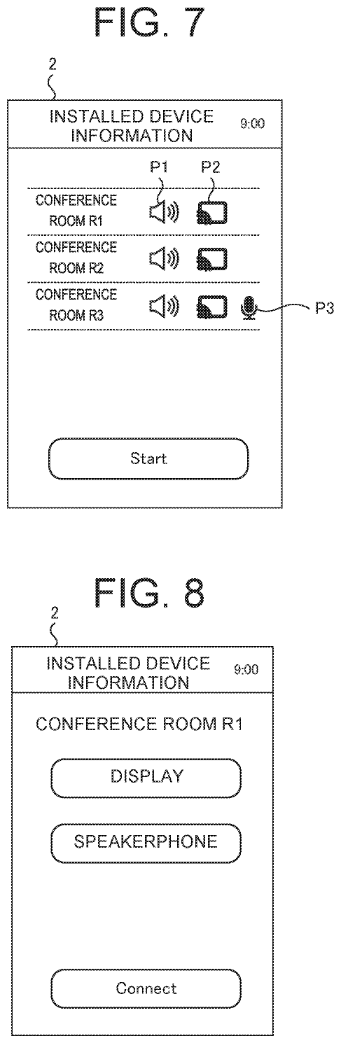

The display processor 211 displays various types of information on the operation display 23. For example, the display processor 211 displays various screens such as the login screen of the conference support application, a conference information screen (see FIG. 6) displaying the conference information D1, and an installed device information screen (see FIGS. 7 to 9) displaying the installed device information D2.

The reception processor 212 receives various operations from the user. For example, the reception processor 212 receives an operation for activating the conference support application from the user. For example, when a conference M1 starts in the conference room R1, the user A performs an operation to activate the conference support application in the user terminal 2 and then the reception processor 212 receives the operation. Further, when the user A performs an operation to input the user ID and the password on the login screen of the conference support application, the reception processor 212 acquires the user ID and the password. When the reception processor 212 acquires the user ID and the password, the management server 1 performs a login process (authentication process) based on the login information.

The first acquisition processor 213 acquires the conference information D1 on the conference. Specifically, the first acquisition processor 213 acquires the time and date information indicating the conference time and date and the conference room information indicating the conference room in which the conference is held. For example, the first acquisition processor 213 acquires the time and date information and the conference room information from the management server 1 that manages the conference information D1 (see FIG. 3). When the user is authenticated by the management server 1, the first acquisition processor 213 acquires the time and date information and the conference room information corresponding to the conference participated by the authenticated user.

When the first acquisition processor 213 acquires the conference information D1 (the time and date information, the conference name, and the conference room information), the display processor 211 displays the conference information D1 on the operation display 23. Specifically, the display processor 211 displays the time and date information and the conference name on the operation display 23 for each conference based on the conference information D1 acquired by the first acquisition processor 213. FIG. 6 illustrates the conference information D1 on the conferences (the conference M1, a conference M2, and a conference M3) participated by the user A. The user may use the conference information screen illustrated in FIG. 6 to understand the conferences to be participated by himself/herself.

The second acquisition processor 214 acquires, from the installed device information D2 (see FIG. 4), the device information (device address information and name) on a predetermined device based on the conference room information acquired by the first acquisition processor 213. For example, the second acquisition processor 214 acquires the device information on the devices installed in the conference room R1, the conference room R2, and a conference room R3 for the conferences (the conference M1, the conference M2, and the conference M3). As illustrated in FIG. 7, the display processor 211 displays an icon image indicating the device for each conference room on the operation display 23. An icon image P1 in FIG. 7 represents the speakerphone 3, an icon image P2 represents a display, and an icon image P3 represents a smart speaker. The user may use the installed device information screen illustrated in FIG. 7 to understand the type of device installed in the conference room. When the user selects (e.g., mouses over) the icon image on the installed device information screen illustrated in FIG. 7, the display processor 211 may display the device information (address information and name) on the device corresponding to the icon image.

According to another embodiment, the reception processor 212 may receive the user's operation of selecting the conference information D1 from the plurality of pieces of the conference information D1 (the time and date information and the conference name) (see FIG. 6) displayed on the user terminal 2. The second acquisition processor 214 may acquire, from the installed device information D2, the device information associated with the conference room information included in the conference information D1 selected by the user. For example, when the user selects “the conference M1” and presses the “start” button on the conference information screen illustrated in FIG. 6, the second acquisition processor 214 acquires, from the installed device information D2 (see FIG. 4), the address information and the name of the display 4 and the address information and the name of the speakerphone 3 associated with the conference room R1 for the conference M1. In this case, the display processor 211 displays, on the operation display 23, the icon images of the display 4 and the speakerphone 3 associated with the conference room R1.

The user selects the conference room for the conference to be participated by himself/herself on the installed device information screen illustrated in FIG. 7. For example, when the user selects “the conference room R1” and presses the “start” button on the installed device information screen illustrated in FIG. 7, the display processor 211 displays a selection screen for selecting a device to which the user terminal 2 is automatically connected, as illustrated in FIG. 8. Here, the display processor 211 presents the display 4 and the speakerphone 3 as the target devices to be connected. To automatically connect the user terminal 2 to both the display 4 and the speakerphone 3, the user selects “display” and “speakerphone” and presses the “connect” button in FIG. 8. The reception processor 212 receives, from the user, the operation of selecting the device to be automatically connected.

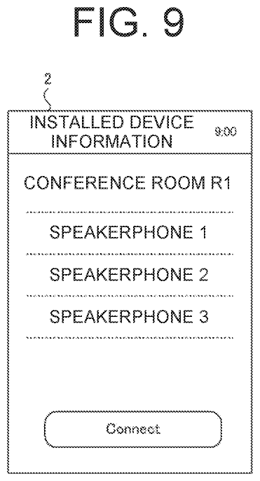

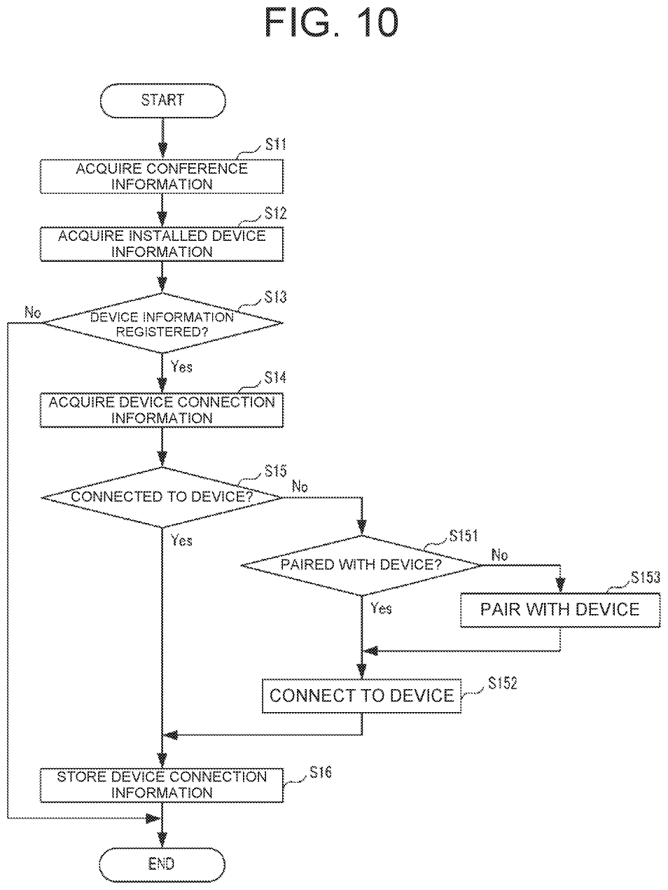

In the installed device information D2, when the device information on the plurality of devices of the identical type is associated with the conference room information included in the conference information D1 selected by the user, the reception processor 212 receives, from the user, an operation of selecting any one of the devices. For example, when three speakerphones 1, 2, and 3 are associated with the conference room R1, the reception processor 212 receives the operation of selecting any one of the speakerphones 1, 2, and 3 from the user on a selection screen illustrated in FIG. 9. In this case, the second acquisition processor 214 acquires, from the installed device information D2, the device information associated with the conference room information included in the conference information D1 selected by the user and the device (any of the speakerphones 1, 2, and 3) selected by the user. When there is the plurality of devices of the identical type in one conference room, the display processor 211 displays the name of each device instead of the device number of each device, as illustrated in FIG. 9, so that the user may easily understand the device to be used for the conference.

According to another embodiment, when the conference information D1 (see FIG. 3) includes the plurality of pieces of conference room information, the controller 21 may perform a process to specify the conference room corresponding to the user participating in the conference from among a plurality of conference rooms. For example, the controller 21 specifies the conference room in accordance with a user's selection operation. For example, the controller 21 acquires the location information on the user and specifies the conference room. The first acquisition processor 213 acquires the conference room information corresponding to the specified conference room, and the second acquisition processor 214 acquires the device information corresponding to the conference room information from the installed device information D2.

The connection processor 215 connects the user terminal 2 to the device based on the device information acquired by the second acquisition processor 214. Specifically, the connection processor 215 performs a pairing process to pair the user terminal 2 with the device. The connection processor 215 performs a connection process to connect the user terminal 2 to the device for which pairing has been conducted. The connection processor 215 connects the user terminal 2 to the device for which the automatic connection setting has been made.

The connection processor 215 performs a process to cancel pairing between the user terminal 2 and the device and a process to terminate the connection between the user terminal 2 and the device. For example, when the connection processor 215 paired the user terminal 2 with the speakerphone 3 and connected the user terminal 2 to the speakerphone 3 at the start of the conference and then received an end operation for the conference from the user, the connection processor 215 terminates the connection between the user terminal 2 and the speakerphone 3 and cancels the pairing between the user terminal 2 and the speakerphone 3.

The connection processor 215 may perform a process to reset the connection status between the user terminal 2 and the device to the status at the start of the conference. For example, when the user terminal 2 and the speakerphone 3 were already paired before the start of the conference, and the connection processor 215 connected the user terminal 2 to the speakerphone 3 at the start of the conference, and then an end operation for the conference was received from the user, the connection processor 215 terminates the connection between the user terminal 2 and the speakerphone 3 and maintains the pairing status between the user terminal 2 and the speakerphone 3. That is, the connection processor 215 performs a process to reset the connection status between the user terminal 2 and the speakerphone 3 to the status (pairing status) at the start of the conference. The controller 21 may terminate the conference when the end operation for the conference is received from the user or may terminate the conference, for example, when the end time of the conference is reached regardless of a user's operation.

For example, when the user terminal 2 and the speakerphone 3 were already connected before the start of the conference and then the end operation for the conference was received from the user, the connection processor 215 maintains the connection between the user terminal 2 and the speakerphone 3. The connection processor 215 may terminate the connection between the user terminal 2 and the speakerphone 3 and cancel the pairing between the user terminal 2 and the speakerphone 3 when the conference is terminated, regardless of the connection status between the user terminal 2 and the speakerphone 3 before the start of the conference.

When the conference is terminated, the display processor 211 causes the operation display 23 to display the conference information screen (see FIG. 6) indicating the conference information D1 (the time and date information and the conference name).

Conference Support Process

With reference to FIGS. 10 and 11, an example of a procedure of the conference support process executed by the conference system 100 is described below.

The present disclosure may be regarded as a disclosure of a conference support processing method (an example of an information processing method according to the present disclosure) for executing one or more steps included in the conference support process. One or more steps included in the conference support process described here may be omitted as appropriate. The execution order of steps in the conference support process may differ as long as the same function effect is obtained. In the example described here, the controller 21 of the user terminal 2 executes each step in the conference support process; however, according to another embodiment, one or more processors may decentrally execute each step in the conference support process. The controller 11 of the management server 1 may execute each step in the conference support process.

Here, the conference support process corresponding to the conference participated by the user A is described as an example. FIG. 10 is a flowchart illustrating an example of a procedure of the conference support process executed by the user terminal 2 at the start of the conference. For example, the controller 21 of the user terminal 2 receives, from the user A, an operation of starting the conference support application and thus starts to execute the conference support processing program so as to start to execute the conference support process. For example, when there is the plurality of user terminals 2 used for the conference, the user terminals 2 perform the conference support process individually and in parallel.

At Step S11, the controller 21 acquires the conference information D1 (see FIG. 3) on the conference. Specifically, the controller 21 acquires, from the management server 1, the time and date information indicating the time and date of each conference associated with the user A and the conference room information indicating the conference room in which the conference is held. When the controller 21 acquires the conference information D1 (the time and date information, the conference name, and the conference room information), the controller 21 displays the conference information D1 on the operation display 23. Specifically, the controller 21 displays the time and date information and the conference name on the operation display 23 for each conference based on the acquired conference information D1 (see FIG. 6). Step S11 is an example of first acquiring according to the present disclosure.

On the conference information screen illustrated in FIG. 6, the controller 21 may receive an operation of selecting the conference information D1 from the user A.

Subsequently, at Step S12, the controller 21 acquires the device information (the installed device information D2 (see FIG. 4)) on a predetermined device based on the conference room information. For example, the controller 21 acquires the installed device information D2 corresponding to the conference rooms R1, R2, and R3 for the conferences (the conferences M1, M2, and M3). As illustrated in FIG. 7, for example, the controller 21 causes the operation display 23 to display, for each conference room, the icon image P1 representing the speakerphone 3, the icon image P2 representing the display 4, and the icon image P3 representing the smart speaker. Step S12 is an example of second acquiring according to the present disclosure.

When the controller 21 receives a selection operation for the predetermined conference information D1 from the user A on the conference information screen illustrated in FIG. 6, the controller 21 may acquire the installed device information D2 associated with the conference room information included in the selected conference information D1.

Subsequently, at Step S13, the controller 21 determines whether the device information (device address information and name) is registered in the acquired installed device information D2. That is, the controller 21 determines whether the device (e.g., speakerphone or display) is installed in the conference room. When the device information is registered in the installed device information D2 (S13: Yes), the process proceeds to Step S14. Conversely, when the device information is not registered in the installed device information D2 (S13: No), the process ends.

At Step S14, the controller 21 acquires the connection status of the device from the device connection information D3 (see FIG. 5). At Step S15, the controller 21 determines whether the user terminal 2 is connected to the device corresponding to the device information. Specifically, the controller 21 refers to the device connection information D3 (see FIG. 5), checks the connection status of the device, and performs the determination process. When the user terminal 2 is connected to the device (S15: Yes), the process proceeds to Step S16. Conversely, when the user terminal 2 is not connected to the device (S15: No), the process proceeds to Step S151.

At Step S151, the controller 21 determines whether the user terminal 2 has been paired with the device corresponding to the device information. Specifically, the controller 21 refers to the device connection information D3 (see FIG. 5), checks the connection status of the device, and performs the determination process. When the user terminal 2 has been paired with the device (S151: Yes), the process proceeds to Step S152. At Step S152, the controller 21 performs a connection process to connect the user terminal 2 to the device. Then, the process proceeds to Step S16.

Conversely, when the user terminal 2 has not been paired with the device (S151: No), the process proceeds to Step S153. At Step S153, the controller 21 performs a pairing process to pair the user terminal 2 with the device. Then, the process proceeds to Step S152. Steps S152 and S153 are examples of connecting according to the present disclosure.

At Step S16, the controller 21 registers the connection status (“pairing” or “connection”) of the device in the device connection information D3 (see FIG. 5). Subsequently, the controller 21 ends the conference support process. When the conference support process has been executed, the user A may conduct a conference (remote conference) using the devices such as the user terminal 2, the speakerphone 3, and the display 4.

FIG. 11 is a flowchart illustrating an example of a procedure of the conference support process executed by the user terminal 2 at the end of the conference.

At Step S21, the controller 21 determines whether an operation (conference end operation) of ending the conference has been received from the user A. When the controller 21 has received the conference end operation from the user A (S21: Yes), the process proceeds to Step S22.

At Step S22, the controller 21 acquires the connection status of the device from the device connection information D3 (see FIG. 5). Here, as the connection status of the device at the start of the conference is registered in the device connection information D3 (see Step S16 in FIG. 10), the controller 21 may acquire the connection status of the device at the start of the conference. For example, the controller 21 acquires the connection status of the speakerphone 3 when the user terminal 2 is connected to the speakerphone 3.

Subsequently, at Step S23, the controller 21 determines whether the pairing process of pairing the user terminal 2 with the device was executed at the start of the conference. When the controller 21 executed the pairing process at the start of the conference (S23: Yes), the process proceeds to Step S24. Conversely, when the controller 21 did not execute the pairing process at the start of the conference (S23: No), the process proceeds to Step S231.

At Step S24, the controller 21 performs a process to terminate the connection between the user terminal 2 and the device. Subsequently, at Step S25, the controller 21 performs a process to cancel the pairing between the user terminal 2 and the device. Specifically, the controller 21 terminates the connection between the user terminal 2 and the device, cancels the pairing with the device, and deletes the address information on the device and the information indicating the connection status from the device connection information D3. Then, the controller 21 ends the conference support process.

At Step S231, the controller 21 determines whether the connection process of connecting the user terminal 2 to the device was executed at the start of the conference. When the controller 21 executed the connection process at the start of the conference (S231: Yes), the process proceeds to Step S232. Conversely, when the controller 21 did not execute the connection process at the start of the conference (S231: No), the process ends.

At Step S232, the controller 21 performs a process to terminate the connection between the user terminal 2 and the device. For example, when the user terminal 2 and the speakerphone 3 were already paired before the start of the conference (S23: No) and the connection process was executed at the start of the conference (S231: Yes), the controller 21 terminates the connection between the user terminal 2 and the device and returns to the connection status (pairing status) before the start of the conference. For example, when the user terminal 2 and the speakerphone 3 were already paired before the start of the conference (S23: No), and the connection process was not executed at the start of the conference (S231: No), the controller 21 maintains the pairing status between the user terminal 2 and the device and ends the process.

As described above, the controller 21 executes the conference support process to start and end the conference.

As described above, the conference system 100 according to the present embodiment is a system that connects the user terminal 2 of the user participating in the conference with the device (the speakerphone 3, the display 4, etc.) used for the conference. The conference system 100 acquires the time and date information indicating the conference time and date and the conference room information indicating the conference room in which the conference is held and, from the storage 22 that stores the conference room information indicating the conference room and the unique device information on the device used for the conference in the conference room in association with each other, acquires the device information on the predetermined device based on the acquired conference room information. The conference system 100 connects the user terminal 2 to the device based on the acquired device information. The configuration described above allows the user to easily connect the user terminal 2 to the device used for the conference, and therefore the conference may be conducted efficiently.

The conference system 100 stores the conference room information and the device information in association with each other (see FIG. 4) and specifies the conference room from the conference information D1 of the schedule information to specify the device to be connected to the user terminal 2; thus, there is no need for the user to select and detect the device. Even when there is the plurality of devices of the same model in one conference room, a list of names of the devices is displayed (see FIG. 9); therefore, the user may easily connect the user terminal 2 to the proper device and may prevent leak of conversation information, and the like, due to the connection to a wrong device.

In a case where there are adjacent conference rooms and there is the plurality of speakerphones 3 within the communication range of short-range wireless communications, the paired devices are automatically connected to each other when the devices are turned on within the communication range according to a conventional technology; however, according to the present disclosure, as the pairing is canceled at the end of the conference, it is possible to prevent the improper connection to the speakerphone 3 in the conference room for a different conference even when the different conference is held in an adjacent conference room.

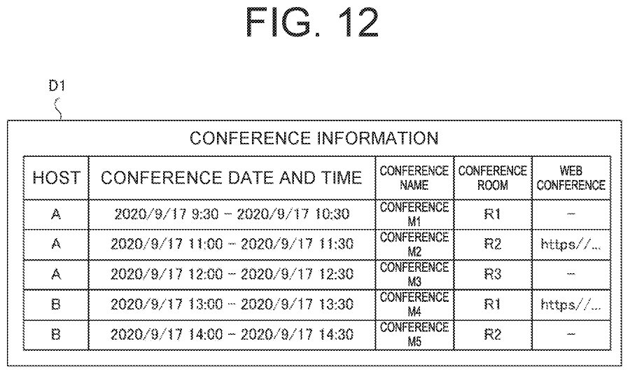

According to another embodiment of the present disclosure, the connection processor 215 may connect the user terminal 2 to the device based on the form of the conference. For example, the speakerphone 3 is a device needed for the conference when the conference is a web conference, and the speakerphone 3 is a device not needed for the conference when the conference is not a web conference. The controller 21 refers to the conference information D1 (see FIG. 12) to determine whether the form of the conference is a web conference. For example, when the form of the conference is set to a web conference in the conference information D1, the connection processor 215 connects the user terminal 2 to the speakerphone 3. Conversely, for example, when the form of the conference is not set to a web conference in the conference information D1, the connection processor 215 does not connect the user terminal 2 to the speakerphone 3.

According to another embodiment of the present disclosure, the connection processor 215 may connect the user terminal 2 to the device based on the setting content of an audio service available for the conference. For example, for the conference, it is possible to make settings as to whether to use an audio service, such as a minutes service for recording audio minutes, or a conversion service for automatically converting a voice to characters (text). The controller 21 determines whether the form of the conference is a conference using a predetermined audio service. Specifically, the controller 21 refers to the conference information D1 to determine whether the audio service has been set. For example, the speakerphone 3 is a device needed for the conference when the audio service is set for the conference, and the speakerphone 3 is a device not needed for the conference when the audio service is not set for the conference. Therefore, for example, when the audio service is set in the conference information D1, the connection processor 215 connects the user terminal 2 to the speakerphone 3. Conversely, for example, when the audio service is not set in the conference information D1, the connection processor 215 does not connect the user terminal 2 to the speakerphone 3.

According to another embodiment, the connection process performed by the connection processor 215 to connect the user terminal 2 to the device may be triggered by the start of the conference or a user operation by the user terminal 2. For example, the connection processor 215 performs the connection process when the user presses a conference record button in the user terminal 2 during the conference. In this case, the connection processor 215 connects to the device in the conference room that is set as the location where the conference is being held.

The device may be a device that does not store authentication information. Typically, Bluetooth-compatible devices execute an authentication process (pairing) for new connection by, for example, long press of a button of the device at the time of a first connection, and as authentication information is stored on both sides after one authentication, the authentication is afterward executed automatically and the connection is established. According to the present embodiment, pairing is canceled (authentication information is deleted) to prevent improper connection to the device after the end of the conference, but some devices need an authentication process again at the time of reconnection as the devices do not store authentication information.

According to another embodiment, the connection processor 215 may be configured to terminate the connection with a device other than the device set for the conference room when the user terminal 2 is connected to the device. This prevents problems such as the continuous connection between the user terminal 2 and the device in another conference room or the leak of voice into another conference room.

According to another embodiment, the management server 1 may display an explanation for the connection when the user terminal 2 and the device are connected to each other. Bluetooth-compatible devices need a user operation such as long-press of a button of the device at the time of a first connection. The user sometimes does not know how to do this as this is different for each device. When there is the plurality of devices in the conference room, it may be difficult to recognize the device in the conference room based on the device name displayed on the user terminal 2. Therefore, the management server 1 specifies the device or displays the explanation for a pairing operation on the user terminal 2 when an operation is needed for the connection to the device. This may prevent a user's improper operation. The management server 1 may display the explanation in the case of a connection error as well as the time of the first connection.

According to another embodiment, the conference system 100 may specify the conference room based on the connected device and start the conference. The conference system 100 acquires a unique ID (MAC address, serial number, etc.) from the connected device. As the management server 1 manages the ID of the device, the conference room may be specified by inquiring the ID, and the conference content may be acquired based on the conference room and the conference time and date. The conference system 100 may start the corresponding conference or start the web conference when the web conference has been set.

According to another embodiment, in order to prevent eavesdropping, the connection processor 215 may keep the connection with the device even when there is no web conference. When there is a need to prevent information leak in an important conference, a private flag is set at the time of booking of the conference so that other users are not allowed to see the content on a schedule application. The connection processor 215 establishes connection with the speakerphone when the private flag is set for the conference, even in the case of a local conference rather than a web conference so as to prevent eavesdropping by a microphone due to the connection from outside the conference room. As only one speakerphone is usually connectable at the same time, the connection with the speakerphone prevents the connection from outside the conference room. The user terminal 2 may also display a dialog prompting the user to check that the speakerphone registered for the conference room is off.

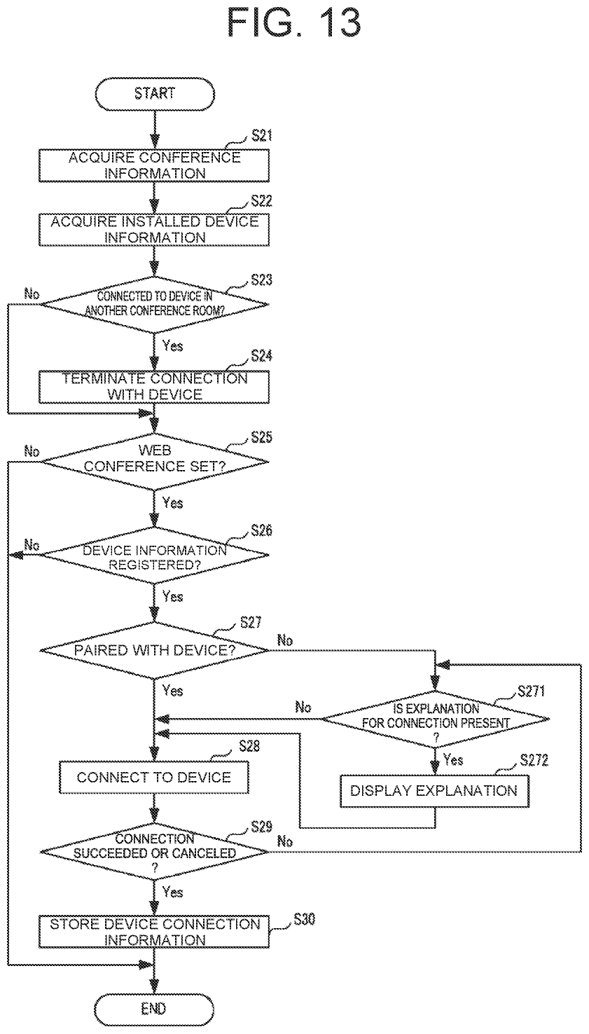

FIG. 13 is a flowchart illustrating an example of an order of another conference support process executed by the conference system 100. Here, a description is simplified for the content common to that in the flowchart illustrated in FIG. 10.

The controller 21 acquires the conference information D1 (the time and date information, the conference name, and the conference room information) on the conference (S21) and acquires the device information (the installed device information D2 (see FIG. 4)) on the predetermined device based on the conference room information (S22).

Subsequently, the controller 21 determines whether the user terminal 2 is connected to the device in another conference room (S23), and when the user terminal 2 is connected (S23: Yes), terminates the connection (S24).

Subsequently, the controller 21 determines whether the web conference is set (see FIG. 12) (S25), and when the web conference is set (S25: Yes), determines whether the device (e.g., speakerphone or display) is installed in the conference room (S26).

When the device is installed in the conference room (S26: Yes), the controller 21 determines whether the user terminal 2 has been paired with the device (S27), and when the user terminal 2 has been paired with the device (S27: Yes), connects the user terminal 2 to the device (S28).

When the user terminal 2 has not been paired with the device (S27: No), the controller 21 determines whether there is an explanation for connection (S271), and when there is the explanation (S271: Yes), displays the explanation on the user terminal 2 (S272).

At Step S29, the controller 21 determines whether the connection has succeeded or has been canceled, and when the connection has succeeded or has been canceled (S29: Yes), registers the connection status of the device in the device connection information D3 (see FIG. 5) (S30). When the connection has not succeeded or has not been canceled (S29: No), the process returns to Step S271. The controller 21 may execute the conference support process as described above.

In the above-described embodiment, the conference system 100 corresponds to the information processing system according to the present disclosure, but the information processing system according to the present disclosure is not limited thereto. For example, the information processing system according to the present disclosure may include the user terminal 2 alone or the management server 1 alone or may include the management server 1 and the user terminal 2.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. An information processing system that connects a user terminal of a user participating in a conference to a device used for the conference, the information processing system comprising:
a first acquisition processor that acquires time and date information indicating time and date of the conference and conference room information indicating a conference room in which the conference is held;
a second acquisition processor that acquires, from a storage that stores the conference room information indicating the conference room and unique device information on the device used for the conference in the conference room in association with each other, the device information on a predetermined device based on the conference room information acquired by the first acquisition processor; and
a connection processor that connects the user terminal to the device based on the device information acquired by the second acquisition processor.

2. The information processing system according to claim 1, further comprising a display processor that causes the user terminal to display conference information including the time and date information and the conference room information for each conference based on the time and date information and the conference room information acquired by the first acquisition processor.

3. The information processing system according to claim 2, further comprising a reception processor that receives an operation of selecting the conference information by the user from the plurality of pieces of conference information displayed on the user terminal.

4. The information processing system according to claim 3, wherein the second acquisition processor acquires, from the storage, the device information associated with the conference room information included in the conference information selected by the user.

5. The information processing system according to claim 3, wherein, when the device information on the plurality of devices of an identical type is associated with the conference room information included in the conference information selected by the user in the storage, the reception processor further receives an operation of selecting any one of the plurality of devices from the user.

6. The information processing system according to claim 5, wherein the second acquisition processor acquires, from the storage, the device information associated with the conference room information included in the conference information selected by the user and the device selected by the user.

7. The information processing system according to claim 1, wherein, when the conference ends, the connection processor terminates a connection between the user terminal and the device and cancels pairing between the user terminal and the device.

8. The information processing system according to claim 1, wherein
when the connection processor paired the user terminal with the device and connected the user terminal to the device at start of the conference and then the conference ended, the connection processor terminates a connection between the user terminal and the device and cancels pairing between the user terminal and the device, and
when the user terminal and the device were paired before the start of the conference, and the connection processor connected the user terminal to the device at the start of the conference and then the conference ended, the connection processor terminates the connection between the user terminal and the device and maintains the pairing between the user terminal and the device.

9. The information processing system according to claim 1, wherein
it is determined whether a form of the conference is a web conference or a conference using a predetermined audio service, and
when the conference is the web conference or the conference using the predetermined audio service, the connection processor connects the user terminal to the device based on the device information acquired by the second acquisition processor.

10. The information processing system according to claim 1, wherein the first acquisition processor acquires the time and date information and the conference room information from a management server that manages conference information.

11. The information processing system according to claim 10, wherein
the user terminal includes the first acquisition processor, the second acquisition processor, and the connection processor, and
the management server transmits the time and date information and the conference room information to the user terminal in accordance with a start time of the conference.

12. An information processing method for connecting a user terminal of a user participating in a conference to a device used for the conference, the information processing method comprising:
by one or more processors, first acquiring time and date information indicating time and date of the conference and conference room information indicating a conference room in which the conference is held;
second acquiring, from a storage that stores the conference room information indicating the conference room and unique device information on the device used for the conference in the conference room in association with each other, the device information on a predetermined device based on the conference room information acquired at the first acquiring; and
connecting the user terminal to the device based on the device information acquired at the second acquiring.

13. A non-transitory computer-readable recording medium having recorded thereon an information processing program for connecting a user terminal of a user participating in a conference to a device used for the conference, the information processing program causing one or more processors to execute:
first acquiring time and date information indicating time and date of the conference and conference room information indicating a conference room in which the conference is held;
second acquiring, from a storage that stores the conference room information indicating the conference room and unique device information on the device used for the conference in the conference room in association with each other, the device information on a predetermined device based on the conference room information acquired at the first acquiring; and
connecting the user terminal to the device based on the device information acquired at the second acquiring.
